(19) United States
(12) Patent Application Publication
(10) Pub. No.: US 2009/0110911 A1
(43) Pub. Date: Apr. 30, 2009

(54) MATERIAL AND JOINT FOR A SHELTER

(76) Inventor: Bruce Simon Van Halderen, Sandton (ZA)

Correspondence Address: DARBY & DARBY P.C., P.O. BOX 770, Church Street Station, New York, NY, 10008-0770, US

(21) Appl. No.: 11/917,749

(22) PCT Filed: Jun. 26, 2006
(86) PCT No.: PCT/IB06/01743

§ 371 Date: Nov. 14, 2008

(30) Foreign Application Priority Data
Jun. 27, 2005 (ZA) 2005/05172

(51) Int. Cl. B32B 7/08

(52) U.S. Cl. 428/332; 428/480; 156/93

(57) ABSTRACT

The patent application discloses a shelter material which comprises a laminate of at least one substrate layer and a membrane, with the substrate layer being a strong elastic layer and the membrane being an elastic waterproof layer. The invention extends to include the substrate layer and the membrane to have full material memory, the shelter material to be treated with a fire retardant agent, an anti-soiling agent, a water repellent, and sealed joints.

### FIELD OF THE INVENTION

This invention relates to a material for a shelter and joint used to join segments of shelter material. The shelter for which the material and joint is intended includes, but is not limited to, tents such as marquee tents, canopies, shade covers, and the like.

### BACKGROUND TO THE INVENTION

Shelters such as tents may be manufactured from synthetic material such as woven material, plastics material and the like. A typical application is camping tents which are manufactured from non-elastic synthetic material. The advantage of such material is that it is typically waterproof and relatively easy to use. It is also relatively easy to seal joints on such shelters by applying a sealant strip to joints in the material.

Larger tents such as marquee or circus tents are also often manufactured from such synthetic non-elastic material which has the similar benefits to camping tents.

A problem with using such material for shelters is that in the case of larger shelters the weight of the material becomes significant. Since the material is not elastic the shape of the shelter is determined by the cut of the material. Although this may not be much of a problem with for example camping tents, it is a limitation in large shelters that are constructed for events such as parties, ceremonies, exhibitions and the like.

In these types of events it is often desirable to have flexibility in the shape of the shelter that is constructed. This is also preferable due to the locations in which such shelters are often constructed or set up, which may vary from a space outside between trees to an indoor space with height restrictions and so on. Using a non-elastic material for a shelter in these types of locations leaves very little room for innovation in terms of the look of the shelter which is constructed.

Another limitation with conventional types of shelter is that it is in many instances quite important to create a specific atmosphere or ambiance using the shelter. Part of this may include the shape and colour of the shelter. Light may also be used to enhance the effect created. The conventional type of non-elastic shelter material is not conducive towards good results when these factors are considered.

For these reasons elastic material with full material memory, which means that over and over again the material returns completely to its in initial state and shape after it has been stretched, has been used for shelters, and for the most the results are significantly better than were possible with conventional shelter material. However, a problem with using elastic material is properly sealing the joints. In addition, the pores in the elastic material also open up under stretching, which may lead to leakage. Since these shelters are often used outdoors the shelter not only has to provide shade but also protection against rain.

Since the material is elastic and the material is significantly stretched during the construction of a shelter, it has not been possible to properly seal joints in the material from which such shelters are manufactured. The joint may be sealed in the normal condition, but upon stretching the material the seal is weakened and over time deteriorates.

In this specification the term shelter includes tents, marquee tents, parking shelters, canopies and the like, which are used to provide shelter against the natural elements including the sun, rain and wind.

### OBJECTIVES OF THE INVENTION

The objectives of this invention include providing a material and a joint for a material that at least partly alleviate the above mentioned problems.

### SUMMARY OF THE INVENTION

In accordance with this invention there is provided a shelter material comprising a laminate of at least one substrate layer and a membrane, the substrate layer being a strong elastic layer and the membrane being an elastic waterproof layer, and preferably for the substrate layer and the membrane to have full material memory.

There is further provided for the shelter material to be treated with a fire retardant agent, preferably a fire retardant chemical, further preferably a commercially available fire retardant chemical by the name of Preflam 8106 available from the Pymag Corporation.

There is also provided for the shelter material to be treated with an anti-soiling and water repelling agent, preferably a chemical, further preferably a fluorocarbon chemical, and further preferably a commercially available fluorocarbon chemical by the name of Pymagard USD available from the Pymag Corporation.

There is further provided for the substrate layer to comprise an elastic mechanical knit fabric, preferably a polyester material.

There is also provided for the membrane layer to preferably comprise an elastic breathable layer, further preferably polyvinyl chloride or polyurethane and preferably having a thickness of at least 12 microns, and more preferably at least 25 microns.

There is still further provided for at least the membrane layer to include an ultra violet light protection compound, preferably titanium dioxide mixed with the compound from which the membrane layer is manufactured.

There is further provided for the substrate layer and membrane layer to be bonded together by means of a hot or a cold glue bonding process, preferably a hot glue bonding process.

There is still further provided for the shelter material to comprise a laminate of two substrate layers separated by a membrane layer.

According to a further feature of the invention there is provided a joint for shelter material comprising a stitch extending through overlapped edges of two segments of shelter material.

There is further provided for the joint to comprise a stitch through double folded overlapped edges of segments of shelter material, and preferably for the folded over edge of each segment to be extended into the fold of the folded edge of the other segment.

There is further provided for the stitch to comprise two rows of stitching, and for at least one row of stitching to comprise a chain stitch, preferably for both rows to comprise chain stitches.

There is still further provided for the segments to preferably be stitched together by cotton yarn, further preferably bonded cotton yarn, further preferably bonded polyester cotton yarn.

There is still further provided for the yarn to be treated with water repellent, preferably a water repellent chemical, further preferably a fluorocarbon chemical.

There is further provided for the joint to be sealed, preferably by means of an elastic sealant, and for the sealant to be chosen from a group of sealants including at least glue, paint, silicone, bitumen, rubber, cement, polyurethane, epoxy, foam, wax, oil, grease, and jelly.

There is also provided for the sealant to be applied on both sides of joined segments of shelter material, preferably covering the stitches.

There is still further provided for the invention to include a method of joining segments of shelter material including the steps of overlapping edges of the segments, stitching the edges together to form a seam, and applying a sealant to at least one side of the seam.

There is further provided for the method to include folding the edges of the segment double before stitching the edges together and preferably for the method to include extending the edge of each segment into the fold of the folded edge of the other segment before stitching the edges together.

There is still further provided for the method to include stitching the segments together by means of a double row of stitches, preferably a double row of chain stitches.

### BRIEF DESCRIPTION OF THE DRAWINGS

Preferred embodiments of a shelter materials and a joint for a shelter material are described below by way of example only and with reference to the accompanying drawings in which:

FIG. 1 is an end view of a first embodiment of shelter material according to the invention;

FIG. 2 is an end view of a second embodiment of shelter material according to the invention; and

FIG. 3 is an end view of a joint used to secure two segments of the second embodiment of shelter material shown in FIG. 2.

### DETAILED DESCRIPTION OF THE INVENTION

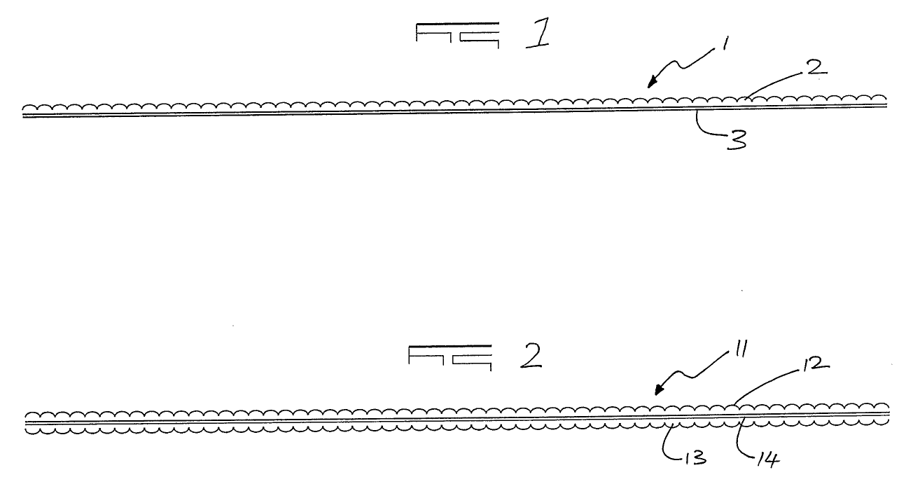

A first embodiment of a shelter material (1) according to the invention is shown in FIG. 1. The material (1) comprises a laminate which includes a substrate layer (2) and a membrane (3).

The substrate layer (2) comprises an elastic mechanical knit fabric with full material memory manufactured from, in this embodiment, a polyester material. The substrate layer is manufactured in a relatively heavy gauge (thickness) to maximise the strength of the shelter material (1).

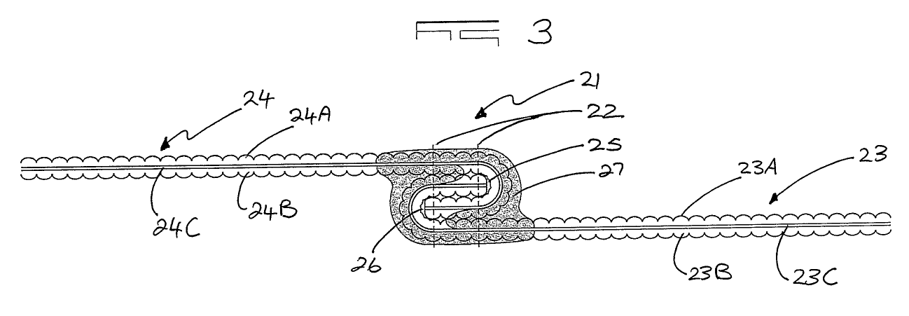

A second embodiment (11), which is a preferred embodiment of a shelter material according to the invention, is shown in FIG. 2. This material (11) comprises a sandwich of two substrate layers (12, 13) separated by a membrane layer (14). The two substrate layers, similar to the first embodiment, comprise elastic mechanical knit fabric with full material memory manufactured from a polyester material.

In both the embodiments (1, 11) the substrate layer (2, 12, 13) may be dyed any colour.

The membrane (3, 14) used in both embodiments (1, 11) is manufactured from a synthetic material which upon application to the substrate layer provides water proofing to the shelter material. The membrane (3, 14) is, in these embodiments, manufactured from polyurethane (PU). The thickness of the membrane layer (3, 14) is preferably about 25 microns.

The membrane layer (3, 14) also includes titanium dioxide (TiO₂). The TiO₂ acts as an ultraviolet (UV) light absorber which protects the shelter material (1, 11). Trials indicate that in the absence of the TiO₂ in the membrane layer, the life of the shelter material is significantly shorter compared to when the membrane includes TiO₂.

The membrane layer (3, 14) is secured to the substrate layer (2, 12, 13) through a bonding process, which includes a hot or cold glue process. In the preferred embodiment (11) shown in FIG. 2 the membrane layer (14) and one substrate layer (12) is bonded and left to cure, after which the second substrate layer (13) is bonded to free side of the membrane layer (14), to form the sandwich of substrate layers (12, 13) and membrane layer (14).

The shelter material (1, 11) is further treated with a fire retardant chemical. In this embodiment the fire retardant chemical is a commercially available product by the name of Preflam 8106 which trials indicate achieves the highest saturation levels of the shelter material. In case the material is subjected to even an open flame the shelter material ( ) will simply melt without catching alight. This is an important feature for a material used in the construction of a shelter used by many people at a time and within which open flames such as candles or gas heaters are often used.

To enhance the anti-soiling characteristics and improve the waterproof characteristics, i.e. reduce the water retention to minimize increase in weight because of wetting, of the shelter material (1, 11) it is treated with water repelling chemicals. Preferred water repelling chemicals are fluoro carbon chemicals, and in these embodiments a commercially available chemical by the name of Pymagard USD is used since it provides the best results and compliments the use of the Preflam 8106 fire retardant chemical.

The fluoro carbon chemicals provide the shelter material (1, 11) with anti soiling characteristics which improves the life of the material (1, 11) by retaining the colour and vibrancy of the material.

The fire retardant chemicals and anti-soiling chemicals are applied to the shelter material (1, 11) prior to stitching segments together to form panels, which is described in detail further on. The fire retardant chemicals and anti-soiling chemicals are applied through a hot or a cold process, although trials have shown that a hot process achieves the greatest level of saturation, typically about 85%, and this type of application is therefore preferred. Even though the normal application of the fire retardant and anti-soiling chemicals occur before a panel is sewn together, it is also possible to topically apply these chemicals once a shelter panel has been manufactured.

The shelter material (1, 11) of the embodiments described provides a material from which a panel may be manufactured which is used to construct a shelter (not shown). The panels may be manufactured in sizes as small as or smaller than 3m×3m (9m²), and as large as or larger than 20m×50m (1000m²). The panels are manufactured from shelter material that is typically about 1.5m wide.

The manufacturing of the panels requires that segments of shelter material be joined. Such joints are normally created by means of stitching to form seams. This introduces another critical feature of the shelter material, namely the strength and waterproof characteristics of the seams.

The preferred embodiment of a joint is a seam (21) shown in FIG. 3 and is a double chain stitch (22). Two segments of shelter material (23, 24) as shown in FIG. 2 are joined by this double chain stitch (22). The edges (25, 26) of the two segments (23, 24) are folded back onto themselves and overlapped, creating a sandwich of four layers of laminates. The edge (25, 26) of each segment (23, 24) is extended between the folded edge (26, 25) of the other segment (24, 23), as shown in FIG. 3. For example the edge (25) of one segment (23) is extended between the edge (26) of the other segment (24) and the segment itself (24), and vice versa.

Considering the structure of the laminate sandwich it will be apparent that it comprises of eight layers of substrate material and four layers of membranes, viewed from the top is this sequence: substrate (24A), membrane (24C), substrate (24B), substrate (23B), membrane (23C), substrate (23A), substrate (24B), membrane (24C), substrate (24A), substrate (23A), membrane (23C), and substrate (23B).

The two rows of chain stitches are made through this sandwich, which creates and exceptionally strong seam (21) between the two segments (23, 24) and improves the strength of the shelter material panel created by it. Trials have shown that by using this seam (21) construction the strength of panel of shelter material is enhanced to the point that the seam is no more the weakest part of a panel. This allows, for example a 1000m² panel to be stretched to almost 1300m², which is significantly greater than what was possible with conventional joints in the shelter material.

The stitches (22) are made, in this embodiment, with a bonded polyester cotton yarn which has been treated with fluorocarbon chemicals. This type of yarn is stronger than conventional fibre cotton yarn and is also more resistant to water leaking on stitching through the shelter material.

To finalise a panel the edges of the panel are stitched with a flat double chain stitch, in other words each edge is folded over once and stitched to itself. Corner rings (not shown) are constructed by sewing stainless steel rings having a minimum thickness of 5 mm and diameter of 50 mm into the panel using reinforcing and bracing with heavy gauge strong material, preferably motor vehicle seatbelt webbing material and straps which are sewn into the corners for improved strength. The tail ends are sewn in at least 55 mm stitching or each tail per loop and with additional reinforced overstitching at diagonals across both tails on each side of the panel and the edge of the panel.

All seams (21) between segments in the panel are finally sealed by applying a stretchable sealant (27) over the seams (21) to cover the entire seam (21) on both sides. A preferred sealant is a commercially available polyurethane product. The sealant is applied manually to at least the seams (21) between segments in the panel. It is not strictly necessary to apply the sealant to the flat double chain stitches at the edges of the panel, since any ingress of water through these stitches will not result in leakage other than directly under such an edge once a shelter has been constructed. However, if desired it is also possible to seal the edge seams with the sealant.

Upon constructing of shelter the shelter material is stretched over erect poles (not shown) and secured to anchors in the ground, walls, or any where else.

Depending on the requirements the shelter may be constructed to be close to or even down to the ground, offering excellent protection against wind, or with enough space to freely walk in underneath the shelter where conditions require more ventilation and free access.

It will be appreciated that the above embodiments are described by way of example only. It is possible, and indeed envisaged, to alter some aspects of the embodiments without departing from the scope of the invention.

It is possible to manufacture the membrane from materials other than PU, for example polyvinylchloride (PVC), polyester (PE), polytetrafluoroethylene (PTFE) or similar materials which introduce waterproofing to the shelter material. The membrane is preferably a material which has low or no breathability and the maximum possible stretchability, whilst retaining its material memory.

It may for example be possible to include TiO₂, or any other ultra violet light absorbent substance, in the material substrate, either as a substitute for the TiO₂ in the membrane or in addition to TiO₂ in the membrane. This may further improve the life of the shelter material upon exposure to the sun.

It is possible to use different types or patterns of stitching with varying degrees of success.

It is possible to use other seam sealant materials with varying degrees of success, for example glues, paints, rubberised paints; sealants which include silicone, bitumen, rubber, cement, polyurethanes, epoxies, foams, wax composites, oils, greases, jellies, and other commercially available proprietary sealants. An important characteristic of the compound used for the sealant is that it must be stretchable since the shelter material panels are stretched significantly in use and yet return to the same state or shape due to the full material memory.

It is possible to use the shelter material for shelters other than just marquee type tents. It may be used for other temporary shelters as well as permanent shelters. An example of a permanent shelter is a carport or a restaurant canopy where this type of material may be used with very good effect to be stretched over a metal frame and secured to anchors. The waterproof characteristics of the material is an improvement over the use of shade net which does not provide much in this regard and as far as sunlight or UV protection is regarded only limited protection. In addition, the shelter material of this invention may also be dyed in any colour which could be used with good effect in a carport.

1. A shelter material comprising a laminate of at least one substrate layer and a membrane, the substrate layer being a strong elastic layer and the membrane being an elastic waterproof layer.

2. A shelter material as claimed in claim 1 in which the substrate layer and the membrane have full material memory.

3. A shelter material as claimed in claim 1 in which the shelter material is treated with a fire retardant agent.

4. A shelter material as claimed in claim 3 in which the fire retardant agent comprises a chemical.

5. A shelter material as claimed in claim 4 in which the fire retardant agent comprises a commercially available fire retardant chemical by the name of Preflam 8106 available from the Pymag Corporation.

6. A shelter material as claimed in claim 1 in which the shelter material to be treated with an anti-soiling and water repelling agent.

7. A shelter material as claimed in claim 6 in which the anti-soiling and water repelling agent comprises a chemical.

8. A shelter material as claimed in claim 7 in which the anti-soiling and water repelling chemical agent comprises a fluorocarbon chemical.

9. A shelter material as claimed in claim 8 in which the fluorocarbon chemical comprises a commercially available fluorocarbon chemical by the name of Pymagard USD available from the Pymag Corporation.

10. A shelter material as claimed in claim 1 in which the substrate layer comprises an elastic mechanical knit fabric.

11. A shelter material as claimed in claim 10 in which the elastic mechanical knit fabric comprises a polyester material.

12. A shelter material as claimed in claim 1 in which the membrane layer comprises an elastic breathable layer.

13. A shelter material as claimed in claim 12 in which the membrane layer comprises a polyvinyl chloride or polyurethane layer.

14. A shelter material as claimed in claim 12 in which the membrane layer has a thickness of at least 12 microns.

15. A shelter material as claimed in claim 12 in which the membrane layer has a thickness of about 25 microns.

16. A shelter material as claimed in claim 1 in which the membrane layer includes an ultra violet light protection compound.

17. A shelter material as claimed in claim 16 in which the ultra violet light protection compound comprises titanium dioxide mixed with the compound from which the membrane layer is manufactured.

18. A shelter material as claimed in claim 1 in which the substrate layer and membrane layer are bonded together by means of a hot or a cold glue bonding process.

19. A shelter material as claimed in claim 1 in which the shelter material comprises a laminate of two substrate layers separated by a membrane layer.

20. A joint for shelter material according to claim 1 comprising a stitch extending through overlapped edges of two segments of shelter material.

21. A joint for shelter material as claimed in claim 20 in which the joint comprises a stitch through double folded overlapped edges of segments of shelter material.

22. A joint for shelter material as claimed in claim 21 in which the folded over edge of each segment is extended into the fold of the folded edge of the other segment.

23. A joint for shelter material as claimed in claim 21 in which the stitch comprises two rows of stitching.

24. A joint for shelter material as claimed in claim 23 in which at least one row of stitching comprises a chain stitch.

25. A joint for shelter material as claimed in claim 23 in which both rows of stitching comprise chain stitches.

26. A joint for shelter material as claimed in claim 20 in which the segments are stitched together by cotton yarn.

27. A joint for shelter material as claimed in claim 26 in which the cotton yarn comprises bonded cotton yarn.

28. A joint for shelter material as claimed in claim 27 in which the cotton yarn comprises bonded polyester cotton yarn.

29. A joint for shelter material as claimed in claim 26 in which the yarn is treated with water repellent.

30. A joint for shelter material as claimed in claim 29 in which the yarn is treated with a chemical water repellent.

31. A joint for shelter material as claimed in claim 29 in which the water repellent comprises a fluorocarbon chemical.

32. A joint for shelter material as claimed in claim 20 in which the joint is sealed.

33. A joint for shelter material as claimed in claim 32 in which the joint is sealed with an elastic sealant.

34. A joint for shelter material as claimed in claim 33 in which the sealant is chosen from a group of sealants including at least glue, paint, silicone, bitumen, rubber, cement, polyurethane, epoxy, foam, wax, oil, grease, and jelly.

35. A joint for a shelter as claimed in claim 32 in which the sealant is applied on both sides of joined segments of shelter material.

36. A joint for a shelter as claimed in claim 35 in which the sealant covers the stitches.

37. A method of joining segments of shelter material which includes the steps of overlapping edges of the segments, stitching the edges together to form a seam, and applying a sealant to at least one side of the seam.

38. A method as claimed in claim 37 which includes the step of folding the edges of the segment double before stitching the edges together.

39. A method as claimed in claim 38 which includes the step of extending the edge of each segment into the fold of the folded edge of the other segment before stitching the edges together

40. A method as claimed in claim 37 which includes the step of stitching the segments together by means of a double row of stitches.

41. A method as claimed in claim 37 which includes the step of stitching the segments together by means of a double row of chain stitches.
